(19) United States
(12) Patent Application Publication
(10) Pub. No.: US 2003/0163782 A1
(43) Pub. Date: Aug. 28, 2003

(54) Form data entry system

(76) Inventor: Benjamin K. Owen, Kirkland, WA (US)

Correspondence Address: Dean A. Craine, DEAN A. CRAINE, P.S., Suite 140, 400 112th Avenue NE, Bellevue, WA, 98004-5542, US

(21) Appl. No.: 10/375,465

(22) Filed: Feb. 26, 2003

Related U.S. Application Data
(60) Provisional application No. 60/360,378, filed on Feb. 27, 2002.

(51) Int. Cl. G06F 15/00

(52) U.S. Cl. 715/505

(57) ABSTRACT

A form information input system that uses a form software program used to make customized “fill-in-the-blank” forms on a host computer. The form software program creates a question for providing information for each blank field in the form, which is transmitted to an input device capable of communicating with the host computer and operated by a user. The input device includes a viewing screen that presents the question to the user. Associated with each question is an empty response field in which the user selects or enters an answer to the question. The answers to all of the questions are stored in the input device memory and then transmitted to the host computer where the information is stored in a combined question and answer data file. Navigation buttons are provided on the input device to move easily between forms and questions. If the user is unsure of the answer to a specific question on the selected form, he or she may skip the question and return later with missing data. The answers from one form may be used in on others forms or on other databases.

This is a utility patent application, which claims benefit of U.S. Provisional Application No. 60/360,378 filed on Feb. 27, 2002.

### BACKGROUND OF THE INVENTION

1. Field of the Invention

This invention pertains to input devices and, more particularly, to portable input devices which present blank fields that are completed by the user and then transmit the information to a main computer.

2. Description of the Related Art

The next generation laptop computers will be ultra thin, lightweight machines that have all of the standard components and features found on a typical desktop computer. Such components will include a motherboard, a large hard drive, a display adaptor, a network adaptor, a sound card, and a built-in monitor with touch screen capabilities. Such devices will also have a plurality of ports enabling it to connect to a wide range of peripherals.

Businesses need a wide range of information from their customers and employees that must be saved into company computers. Often, the information is collected from forms or questionnaires completed by the customers or employees which are later entered into the computer. While some of the information requested may be general in nature, such as “name,” “address,” “telephone number,” etc, some of the information requested is very specific and detailed, such as “the names of heart medications that you are taking.” Many businesses need a wide range of customized forms.

Form software programs exist that enable users to prepare customized forms that are printed out and manually completed. Form software programs in which a “form-like” graphic file is transmitted to a viewing screen that enables users to input information into blank fields on the form also exist. The completed form, along with the answers typed into the fields, are then stored in a data file created by the software program. If the computer is connected via a cable or network to a second computer with the form software program loaded into its memory, the entire completed form may be downloaded and reviewed on the second computer.

One drawback with “form software programs” found in the prior art is that each computer must have a copy of the software program loaded into its memory in order to view the form. Another drawback is that records typed in the fields of one form cannot be used in the fields in another form or another program. A further drawback is that providing multiple copies of the form software program, written in different languages, is expensive.

It is common for individuals in a region to speak different languages. Typically, when information is collected on a printed form, questions on the form must be printed in a language understood by the user. For companies that must collect information directly from individuals, printed forms written in different languages must be prepared. If a form software program is used, complete foreign language versions of the software program must be used.

### SUMMARY OF THE INVENTION

It is an object of the present invention to provide a form data entry system that makes customized forms used to collect information from users using a handheld input device.

It is another object of the present invention to provide such a system wherein the customized form includes a plurality of empty fields intended to be completed by the user answering simple questions.

It is another object of the invention to provide such a system in which the simple questions are individually presented to the user via the input device and the answers are collected in a saved data file that can then be used in other forms or exported to other software programs later.

It is a further object of the invention to provide such a system in which the questions associated with the empty fields can be easily presented in different languages.

These and other objects are met by a form data entry system disclosed herein that uses a form software program used to make customized “fill-in-the-blank” forms. The form software program, which is loaded into the memory of a host computer, produces forms comprising a plurality of empty fields that are filled in or completed by the user. Associated with each empty field is a simple question that requires a check, a multiple-choice answer, or a short inputted response from the user. The set of questions used with the form are stored in a question data file. Once the entire form and question data file are created, the question data file is then transferred to a handheld input device where the questions are individually presented to a user for answering. The input device includes a viewing screen on which each question along with a box, letter, number of multiple-choice answer, or blank line is presented. The viewing screen may also include a touch-pad capability that presents an alphanumeric keypad that enables the user to type words or numbers into the blank line. Optional navigation buttons are also provided on the input device or the view screen that enable the user to move easily between questions.

When an answer to each question, also called a record, is submitted by the user, it is automatically saved in the answer data file. In the preferred embodiment, the answer data file is saved in the memory of the input device. When all of the questions are answered, the entire answer data file is then transferred to the host computer. It should be understood that each record could also be sent to an answer data file saved on the host computer.

The form software program is used to create the form layout, the nature of the questions presented to the user (i.e. question data file), the format of the answers (i.e yes/no, true/false, fill-in the blank, etc.) to be submitted by the user, and the order of questions presented to the user. The form software program also controls the data modification, file transfer, network communication functions, security functions and help functions.

Because the answer data file contains one word, one number, or simple answers, it can be copied and used on other forms or combined with other databases that use the same or similar question data files, thereby eliminating the need to repeat data entry. By creating a question data file that contains a complete set of questions associated with the form, replacement data files can be used that contain foreign language translations of the questions for presentation to foreign language speaking users.

### DESCRIPTION OF THE DRAWINGS

FIG. 1 is an illustration depicting the form data entry system discussed herein.

FIG. 2 is a flow chart of the system.

FIG. 3 is a top plan view of the input device.

FIG. 4 is a side elevational view of the input device.

FIG. 5 is an illustration of the display on the input device showing an image of the representative form, an input box, and a representative keyboard used to type information into the input box.

FIGS. 6-10 are representative images shown on the display in which a question is presented and optional input buttons are displayed.

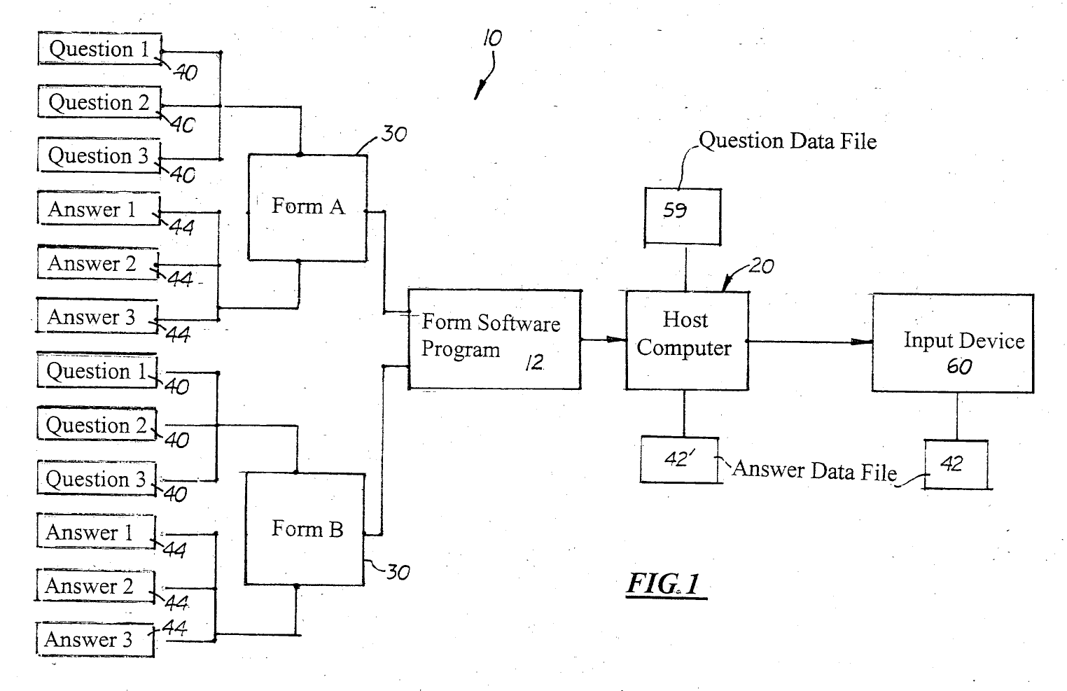

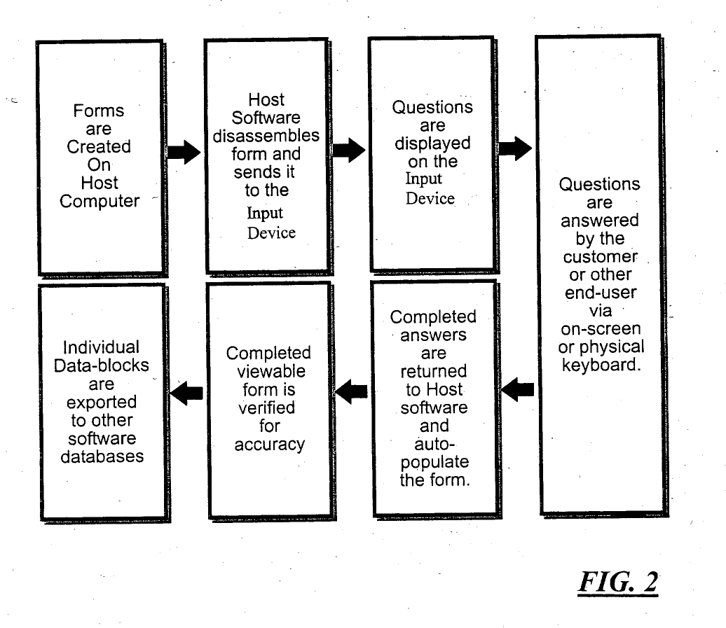

### DESCRIPTION OF THE PREFERRED EMBODIMENT(S)

Described herein is a form data entry system, generally indicated as 10, that uses a form software program 12 to make a customized “fill-in-the-blank” form 30 where each blank field 32 in the form 30 is associated with a simple question 40 that is presented to a user via a handheld input device 60. The set of questions 39 that are used with the form 30 are saved in a question data file 59. When a form 30 and the associated question data file 59 are created, only the question data file 59 is transmitted to the input device 60. The individual questions 40 are then presented to the user while operating the input device 60 who inputs answers to the questions 40. The complete set of simple or short answers 44 is stored in an answer data file 42 which is created on the input device 60 and then transmitted to a host computer 20 or stored in an answer data file 42′ created on the host computer 20.

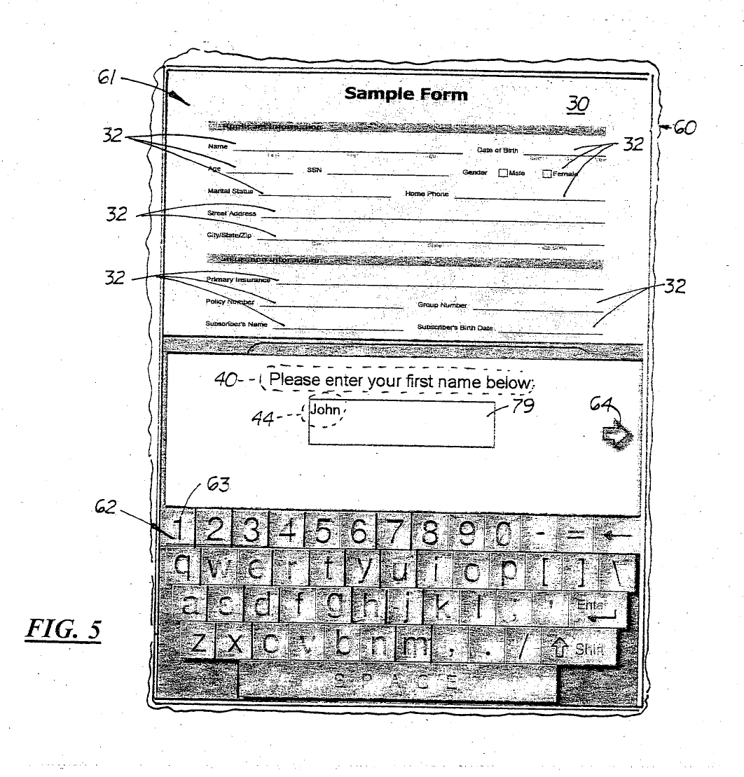

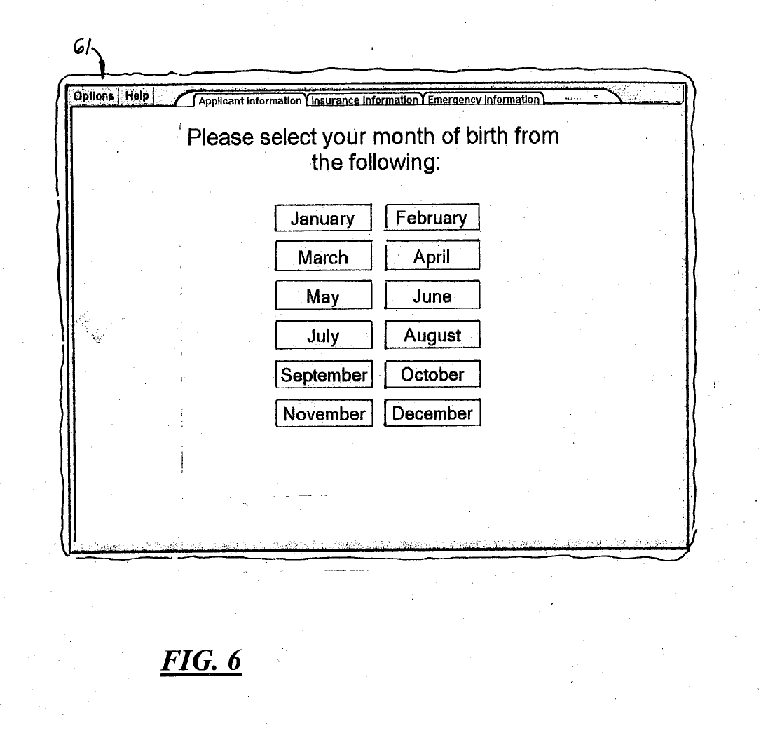

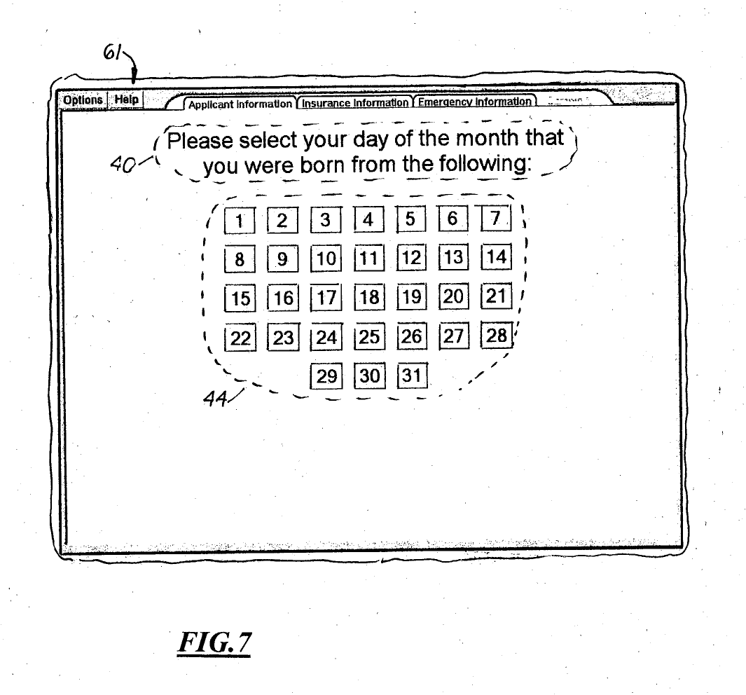

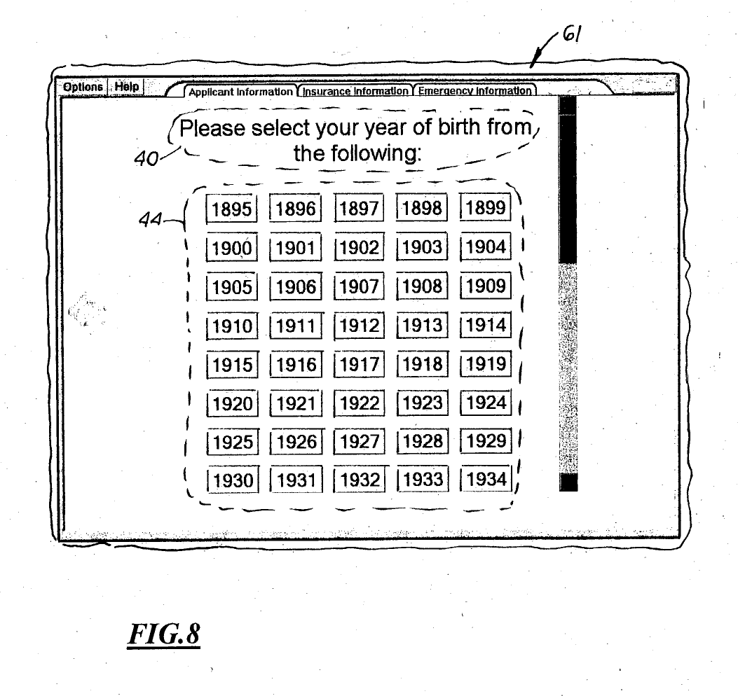

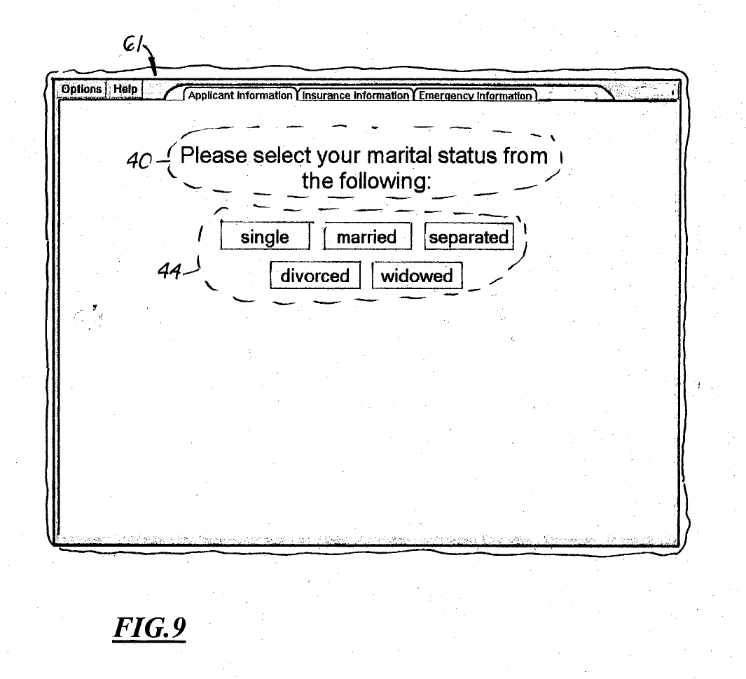

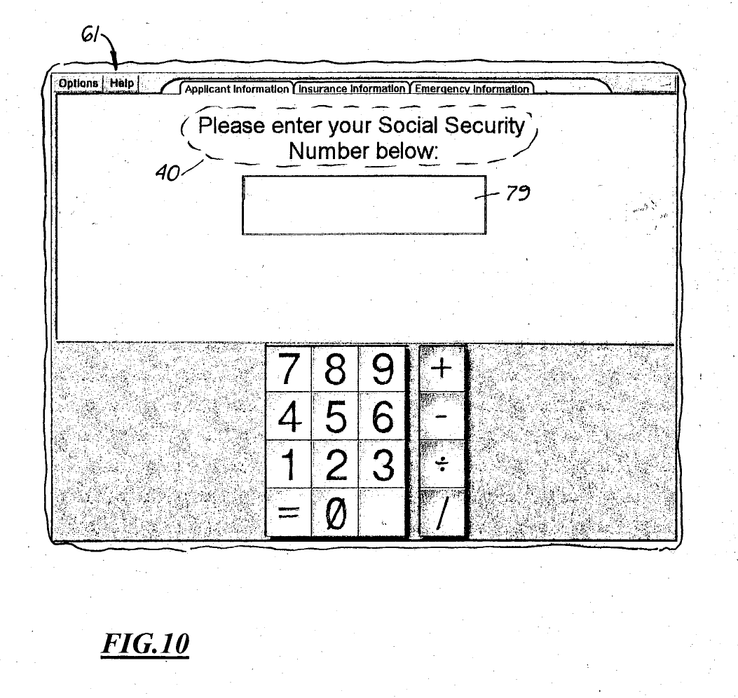

The system 10 includes a host computer 20, a form software program 12 loaded into the working memory of the host computer 20, and an input device 60 in communication with the host computer 20. During operation, a customized “fill-in-the-blank” form 30 is created in the host computer 20 using the form software program 12. The form 30, a representative being shown in FIG. 5, contains a plurality of blank fields 32 designed to be completed with information supplied by the user. Each blank field 32 is associated with a single or short-answer question 40 which is individually presented to the user via the viewing screen 61 on the input device 60. Once the form 30 and questions 40 are created, the entire questions data file 59 is then transmitted to the input device 60. A viewing screen 61 on the input device 60 then displays the individual question, 40 shown, along with a blank line or single or multiple short answer buttons or box 70, 75, 76, 78, 79, as shown in FIGS. 6-10. As shown in FIG. 5, the viewing screen 61 may also present an alphanumeric keypad 62 with a plurality of touch keys 63 which enable the user to type words or numbers into the blank line or select a short answer button 70, 75, 76, 78, 79. The questions 40 are arranged so that they are presented in the order presented on the form 30. In the preferred embodiment, the next question 40 will only be provided after the answer 44 to the previous question 40 is provided. After all of the questions 40 have been answered the entire completed form 30 will be presented to the user.

In the preferred embodiment, the viewing screen 61 has touch-screen functionality. As shown on FIG. 5, at least one navigational button 64 may be displayed on the viewing screen 61 that the user touches to move easily between forms 30 and questions 40. If the user does not know, or is unsure of, an answer 44 to a specific question 40 on the selected form 30, he or she may also use the button 64 to skip the question 40 and return later with missing data.

In the preferred embodiment, the system 10 is designed so that after all of the questions 40 in the question data file 59 have been answered and stored in the answer data file 42 on the input device 60, the entire answer data file 42 is then transmitted to the host computer 20. In other embodiments, the answers 44 to specific questions 40 in the question data file 59 could be individually transferred to an answer data file 42′ located on the host computer 20. In both embodiments, the answer data files 42, 42′ are then used with the form data file 43 to reassemble the completed form 30 which then maybe presented to the user on the viewing screen 61.

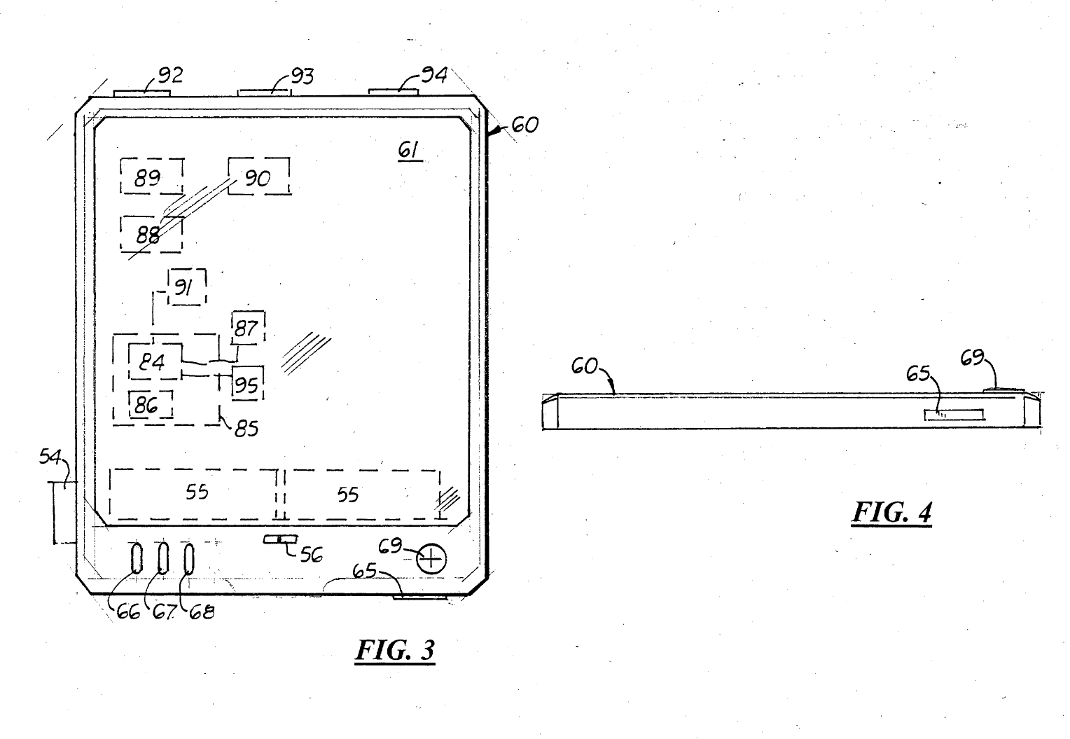

As shown in FIGS. 3 and 4, the input device 60 is a thin and lightweight device similar to a single sheet of paper with a frame around it. The viewing screen 61 measures approximately 8½×10 inches, with an overall minimal frame thickness of approximately three-fourths inch. Embedded within the outer frame of the input device 60 is a plurality of control buttons, such as power on/off 65, contrast higher 66, contrast lower 66, backlight on/off 68, and four directional arrow buttons 69. In addition to these controls, there are several ports 54 mounted on the sides of the device 60 for communicating with the outside world, such as an IRDA window for establishing a two way infrared data link, a USB connector, a network port, or RJ-45 telephone jack connector.

The input device 60 includes internal rechargeable batteries 55 that may be recharged with an AC combination recharger/adaptor (not shown). A special power down mode is also provided through the power on/off button 65, allowing the input device 60 to go into a lower power, “standby” state while retaining its current condition. This functionality will provide extended run times, while protecting the user data. If the user accidentally presses the power on/off button 65, data will not be lost. An optional battery level indicator 56 will be provided, and warnings given before an ultimate battery power loss that would result in lost data.

In the preferred embodiment, the input device 60 also contains a main processor 85, an operating software 87, 16 MB RAM, 4 MB Flash ROM 88, an internal modem or network 89, a 1.8V/3.3V/5V power supply 90, a CCFL inverter 91 for display back lighting, a keypad interface logic 92, an USB host/function interface 93, IRDA module 94, and a LCD controller 95. Built into the input device 60 is the LCD viewing screen 61 that provides standard VGA resolution of 640×480. The base operating software 87 for the input device 60 is Linux.

To make text entry more efficient, the input device 60 operating software 87 may include an auto-completion function that uses a common word list. A help button will be provided on the viewing screen 61. During operation, the user may require additional help regarding a specific question 40. He or she may skip the question 40 and move on to the next question 40. After the completed form 30 has been reassembled by the host computer 20 or input device 60, all skipped questions 40 are highlighted on the viewing screen 61 or the host computer 20 monitor 26, and assistance can be given. At this point, the missing information can be entered into the host computer 20 directly via the host computer keyboard or mouse or through the input device 60. The new completed answer 44 is then added to the answer data file 42. This system 10 allows all outside help to be administered at one time, similar to a paper-based system. Once all parties are satisfied with the answers 44, the answer data file 42 is then transferred to the host computer 20. The input device 60 is ready for a new form 30.

The form software program 12 is also designed to communicate with other external databases residing on the host computer 20 or a network that the host computer 20 connects. The specific answers 44 or the entire answer data file 42 can be selected and transferred to an external database using export trees to define specific paths for all future data export processes. The form software program 12 is also designed to read other specified external software applications to validate and/or make any necessary changes or updates to the answers.

In compliance with the statute, the invention described herein has been described in language more or less specific as to structural features. It should be understood, however, that the invention is not limited to the specific features shown, since the means and construction shown, is comprised only of the preferred embodiments for putting the invention into effect. The invention is therefore claimed in any of its forms or modifications within the legitimate and valid scope of the amended claims, appropriately interpreted in accordance with the doctrine of equivalents.

I claim:

1. A form data input system, comprising;
a. a host computer;
b. a form software program loaded into the memory of said host computer, said form software program used to create a form with a plurality of fields that require specific information inputted from a user, said software program being used to generate at least one question associated with each said field on said form;
c. an input device used to communicate with said host computer, said input device having a user interface used to communicate said questions created by said software program to said user, and an input means including means for answering said questions, and;
d. memory storage means used to store said answers in said input device.

2. The form data input system, as recited in claim 1, wherein the entire set of said questions used on said form are transmitted to said input device.

3. The form data input system, as recited in claim 1, wherein the answers to said questions are collected on an answer data file and transmitted to said host computer.

4. The form data input system, as recited in claim 1, wherein the answers to said questions are transmitted individually to said host computer.

5. The form data input system, as recited in claim 3, further including a wireless communication link enabling said host computer to communicate with said input device.

6. The form data input system, as recited in claim 4, further including a wireless communication link enabling said host computer to communicate with said input device.
